(19) United States
(12) Patent Application Publication
(10) Pub. No.: US 2025/0175943 A1
(43) Pub. Date: May 29, 2025

(54) COMMUNICATION CONTROL METHOD

(71) Applicant: KYOCERA Corporation, Kyoto (JP)

(72) Inventors: Mitsutaka HATA, Yokohama-shi (JP); Masato FUJISHIRO, Yokohama-shi (JP)

(73) Assignee: KYOCERA Corporation, Kyoto (JP)

(21) Appl. No.: 19/037,582

(22) Filed: Jan. 27, 2025

Related U.S. Application Data
(63) Continuation of application No. PCT/JP2023/027045, filed on Jul. 24, 2023.

(30) Foreign Application Priority Data
Jul. 27, 2022 (JP) 2022-119404

(51) Int. Cl. H04W 68/00; H04W 36/14; H04W 48/08

(52) U.S. Cl. CPC H04W 68/00; H04W 36/14; H04W 48/08

(57) ABSTRACT

A communication control method according to one aspect is a communication control method in a mobile communication system. The communication control method includes transmitting, by a base station, a first paging message associated with a network slice to a user equipment.

### RELATED APPLICATIONS

The present application is a continuation based on PCT Application No. PCT/JP2023/027045, filed on Jul. 24, 2023, which claims the benefit of Japanese Patent Application No. 2022-119404 filed on Jul. 27, 2022. The content of which is incorporated by reference herein in their entirety.

### TECHNICAL FIELD

The present disclosure relates to a communication control method in mobile communication systems.

### BACKGROUND

Specifications of the Third Generation Partnership Project (3GPP) (trade name; the same applies hereinbelow), which is a standardization project for mobile communication systems, define network slicing. Network slicing is a technique of logically dividing a physical network constructed by a telecommunications carrier to configure network slices that are virtual networks.

A user equipment in a radio resource control (RRC) idle state or an RRC inactive state can perform a cell reselection procedure. The 3GPP has studied slice-specific cell reselection, slice aware cell reselection, or slice based cell reselection that is a network slice-dependent cell reselection procedure (for example, see Non-Patent Document 1). By performing the slice-specific cell reselection procedure, the user equipment can camp on, for example, a neighboring cell supporting a desired network slice.

### CITATION LIST

### Non-Patent Literature

Non-Patent Document 1: 3GPP TS 38.300 V17.8.0 (2022-3)

### SUMMARY

In one aspect, a communication control method is a communication control method in a mobile communication system. The communication control method includes transmitting, by a base station to a user equipment, a first paging message associated with a network slice.

### BRIEF DESCRIPTION OF THE DRAWINGS

FIG. 1 is a diagram illustrating a configuration example of a mobile communication system according to a first embodiment.

FIG. 2 is a diagram illustrating a configuration example of a user equipment (UE) according to the first embodiment.

FIG. 3 is a diagram illustrating a configuration example of a gNB (base station) according to the first embodiment.

FIG. 4 is a diagram illustrating a configuration example of a protocol stack for a user plane according to the first embodiment.

FIG. 5 is a diagram illustrating a configuration example of a protocol stack for a control plane according to the first embodiment.

FIG. 6 is a diagram for illustrating an overview of a cell reselection procedure.

FIG. 7 is a flowchart illustrating a schematic flow of a typical cell reselection procedure.

FIG. 8 is a diagram illustrating an example of network slicing.

FIG. 9 is a diagram illustrating an overview of a slice-specific cell reselection procedure.

FIG. 10 is a diagram illustrating an example of slice frequency information.

FIG. 11 is a flowchart illustrating a basic flow of the slice-specific cell reselection procedure.

FIG. 12 is a diagram illustrating an operation example according to the first embodiment.

FIG. 13 is a diagram illustrating an operation example according to a second embodiment.

FIG. 14 is a diagram illustrating an operation example according to a third embodiment.

### DESCRIPTION OF EMBODIMENTS

An object of the present disclosure is to provide a communication control method in which a user equipment can connect to an appropriate cell.

A mobile communication system according to an embodiment is described with reference to the drawings. In the description of the drawings, the same or similar parts are denoted by the same or similar reference signs.

### First Embodiment

### Configuration of Mobile Communication System

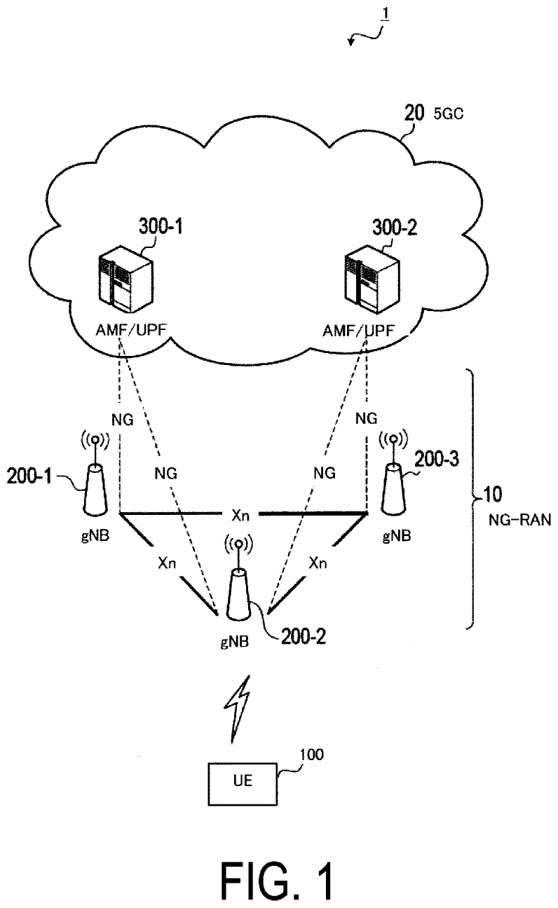

FIG. 1 is a diagram illustrating a configuration of a mobile communication system according to a first embodiment. The mobile communication system 1 complies with the 5th Generation System (5GS) of the 3GPP standard. The description below takes the 5GS as an example, but Long Term Evolution (LTE) system may be at least partially applied to the mobile communication system. A sixth generation (6G) system may be at least partially applied to the mobile communication system.

The mobile communication system 1 includes a User Equipment (UE) 100, a 5G radio access network (Next Generation Radio Access Network (NG-RAN)) 10, and a 5G Core Network (5GC) 20. The NG-RAN 10 may be hereinafter simply referred to as a RAN 10. The 5GC 20 may be simply referred to as a core network (CN) 20.

The UE 100 is a mobile wireless communication apparatus. The UE 100 may be any apparatus as long as the UE 100 is used by a user. Examples of the UE 100 include a mobile phone terminal (including a smartphone) or a tablet terminal, a notebook PC, a communication module (including a communication card or a chipset), a sensor or an apparatus provided on a sensor, a vehicle or an apparatus provided on a vehicle (Vehicle UE), and a flying object or an apparatus provided on a flying object (Aerial UE).

The NG-RAN 10 includes base stations (referred to as “gNBs” in the 5G system) 200. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter simply referred to as one “frequency”).

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF are connected to the gNB 200 via an NG interface which is an interface between a base station and the core network.

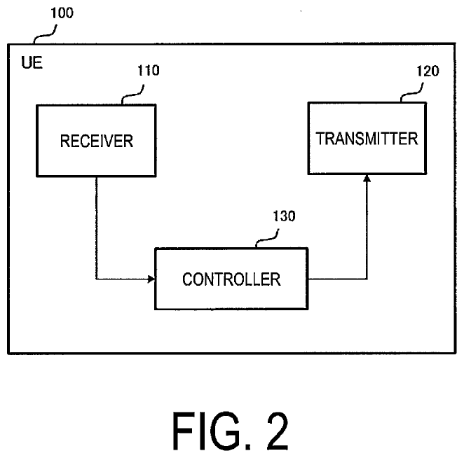

FIG. 2 is a diagram illustrating a configuration of the user equipment (UE) 100 according to the first embodiment. The UE 100 includes a receiver 110, a transmitter 120, and a controller 130. The receiver 110 and the transmitter 120 constitute a wireless communicator that performs wireless communication with the gNB 200.

The receiver 110 performs various types of reception under control of the controller 130. The receiver 110 includes an antenna and a reception device. The reception device converts a radio signal received through the antenna into a baseband signal (a reception signal) and outputs the resulting signal to the controller 130.

The transmitter 120 performs various types of transmission under control of the controller 130. The transmitter 120 includes an antenna and a transmission device. The transmission device converts a baseband signal (a transmission signal) output by the controller 130 into a radio signal and transmits the resulting signal through the antenna.

The controller 130 performs various types of control and processing in the UE 100. Such processing includes processing of respective layers to be described later. The controller 130 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing. Note that the controller 130 may perform each processing and each operation in the UE 100 in each embodiment to be described below.

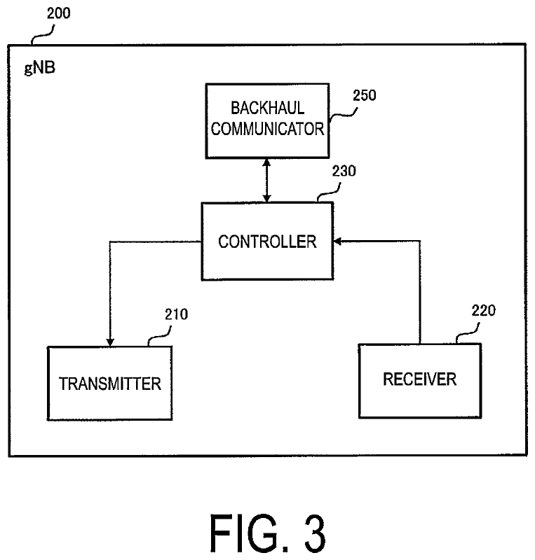

FIG. 3 is a diagram illustrating a configuration of the gNB 200 (base station) according to the first embodiment. The gNB 200 includes a transmitter 210, a receiver 220, a controller 230, and a backhaul communicator 240. The transmitter 210 and the receiver 220 constitute a wireless communicator that performs wireless communication with the UE 100. The backhaul communicator 240 constitutes a network communicator that performs communication with the CN 20.

The transmitter 210 performs various types of transmission under control of the controller 230. The transmitter 210 includes an antenna and a transmission device. The transmission device converts a baseband signal (a transmission signal) output by the controller 230 into a radio signal and transmits the resulting signal through the antenna.

The receiver 220 performs various types of reception under control of the controller 230. The receiver 220 includes an antenna and a reception device. The reception device converts a radio signal received through the antenna into a baseband signal (a reception signal) and outputs the resulting signal to the controller 230.

The controller 230 performs various types of control and processing in the gNB 200. Such processing includes processing of respective layers to be described later. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing. Note that the controller 230 may perform all of the processing and operations in the gNB 200 in each embodiment to be described below.

The backhaul communicator 240 is connected to a neighboring base station via an Xn interface which is an inter-base station interface. The backhaul communicator 240 is connected to the AMF/UPF 300 via a NG interface between a base station and the core network. Note that the gNB 200 may include a Central Unit (CU) and a Distributed Unit (DU) (i.e., functions are divided), and the two units may be connected via an F1 interface, which is a fronthaul interface.

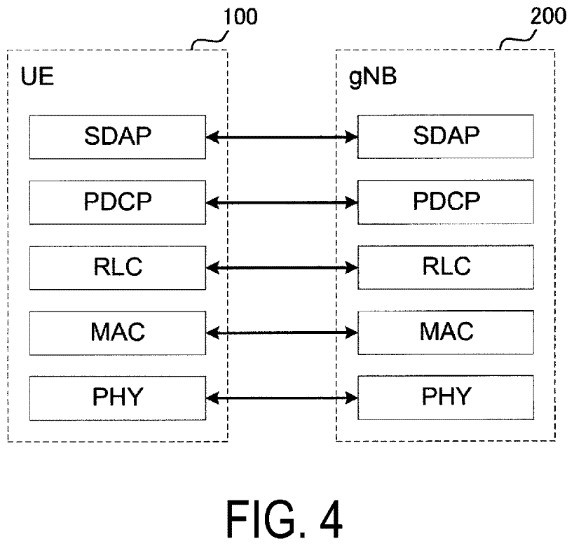

FIG. 4 is a diagram illustrating a configuration of a protocol stack of a radio interface of a user plane handling data.

A radio interface protocol of the user plane includes a physical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 blind decodes the PDCCH using a radio network temporary identifier (RNTI) and acquires successfully decoded DCI as DCI addressed to the UE 100. The DCI transmitted from the gNB 200 is appended with CRC parity bits scrambled by the RNTI.

The MAC layer performs priority control of data, retransmission processing through hybrid ARQ (HARQ: Hybrid Automatic Repeat reQuest), a random access procedure, and the like. Data and control information are transmitted between the MAC layer of the UE 100 and the MAC layer of the gNB 200 via a transport channel. The MAC layer of the gNB 200 includes a scheduler. The scheduler decides transport formats (transport block sizes, Modulation and Coding Schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between an IP flow as the unit of Quality of Service (QOS) control performed by a core network and a radio bearer as the unit of QoS control performed by an Access Stratum (AS). Note that, when the RAN is connected to the EPC, the SDAP need not be provided.

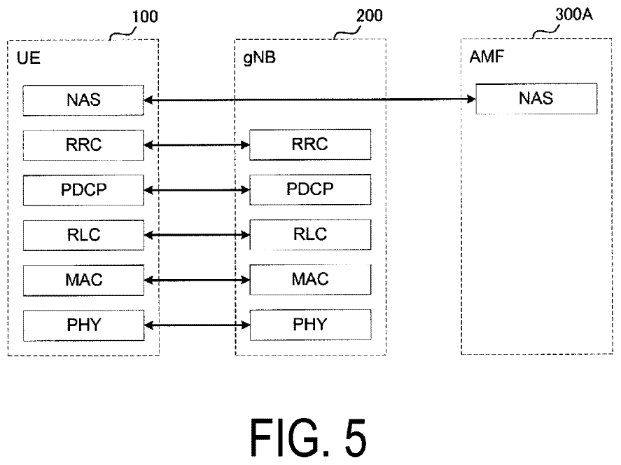

FIG. 5 is a diagram illustrating a configuration of a protocol stack of a radio interface of a control plane handling signaling (a control signal).

The protocol stack of the radio interface of the control plane includes a Radio Resource Control (RRC) layer and a Non-Access Stratum (NAS) layer instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection (RRC connection) between the RRC of the UE 100 and the RRC of the gNB 200 is present, the UE 100 is in an RRC connected state. When no connection (RRC connection) between the RRC of the UE 100 and the RRC of the gNB 200 is present, the UE 100 is in an RRC idle state. When the connection between the RRC of the UE 100 and the RRC of the gNB 200 is suspended, the UE 100 is in an RRC inactive state.

The NAS which is positioned upper than the RRC layer performs session management, mobility management, and the like. NAS signaling is transmitted between the NAS of the UE 100 and the NAS of the AMF 300. Note that the UE 100 includes an application layer other than the protocol of the radio interface. A layer lower than the NAS is referred to as Access Stratum (AS).

### Overview of Cell Reselection Procedure

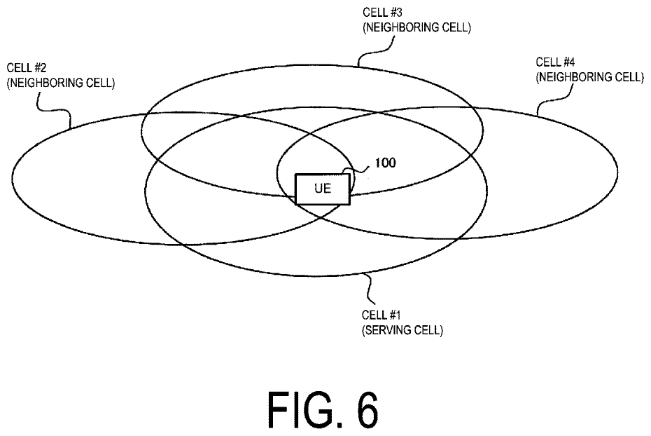

FIG. 6 is a diagram for illustrating an overview of a cell reselection procedure.

The UE 100 in the RRC idle state or the RRC inactive state performs the cell reselection procedure to migrate from a current serving cell (cell #1) to a neighboring cell (any one of cells #2 to #4) according to its movement. To be more specific, the UE 100 specifies a neighboring cell to which the UE is to camp on through the cell reselection procedure and reselects the specified neighboring cell. A frequency (carrier frequency) being the same for the current serving cell and the neighboring cell is referred to as an intra-frequency, and a frequency (carrier frequency) being different for the current serving cell and the neighboring cell is referred to as an inter-frequency. The current serving cell and the neighboring cell may be managed by the same gNB 200. The current serving cell and the neighboring cell may be managed by the gNBs 200 different from each other.

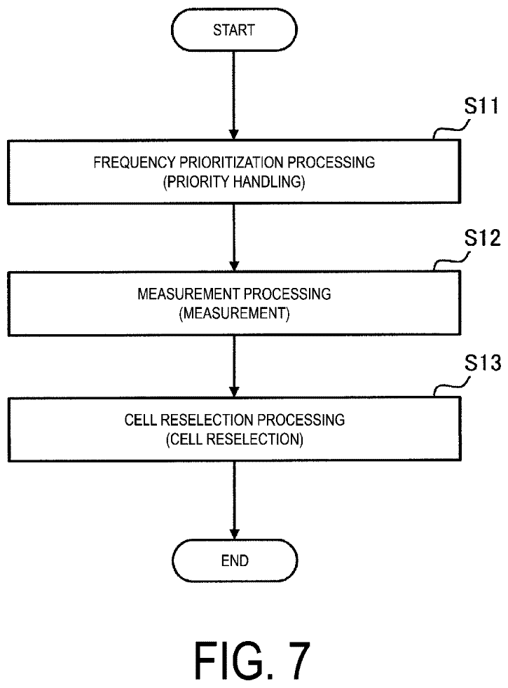

FIG. 7 is a flowchart illustrating a schematic flow of a typical (or legacy) cell reselection procedure.

In step S11, the UE 100 performs frequency priority handling processing based on frequency-specific priorities (also referred to as “absolute priorities”) specified by the gNB 200, for example, by way of a system information block or an RRC release message. To be more specific, the UE 100 manages the frequency priority designated by the gNB 200 for each frequency.

In step S12, the UE 100 performs measurement processing of measuring radio qualities of the serving cell and each of the neighboring cells. The UE 100 measures reception powers and reception qualities of reference signals transmitted by the serving cell and each of the neighboring cells, to be more specific, a cell defining-synchronization signal and PBCH block (CD-SSB). For example, the UE 100 always measures the radio quality of the frequencies having a higher priority than that of the frequency of the current serving cell, and for frequencies having a priority equal to or lower than the priority of the frequency of the current serving cell, measures the radio quality of the frequencies having a priority equal to or lower than the priority of the frequency of the current serving cell when the radio quality of the current serving cell is below a predetermined quality.

In step S13, the UE 100 performs the cell reselection processing of reselecting a cell to which the UE 100 camps on based on the measurement result in step S12. For example, when the priority of a frequency of a neighboring cell is higher than the priority of the current serving cell and the neighboring cell satisfies a predetermined quality standard (i.e., a minimal required quality standard) for a predetermined period of time, the UE 100 may perform cell reselection for the neighboring cell. When the priorities of the frequencies of the neighboring cells are the same as the priority of the current serving cell, the UE 100 may rank the radio qualities of the neighboring cells to perform cell reselection for the neighboring cells ranked higher than the ranking of the current serving cell for a predetermined period of time. When the priority of the frequency of the neighboring cell is lower than the priority of the current serving cell, the radio quality of the current serving cell is lower than a certain threshold, and the radio quality of the neighboring cell is continuously higher than another threshold for the predetermined period of time, the UE 100 may perform cell reselection for the neighboring cell.

### Overview of Network Slicing

Network slicing is a technique of virtually dividing a physical network (for example, a network including the NG-RAN 10 and the 5GC 20) constructed by a telecommunications carrier to create a plurality of virtual networks. Each virtual network is referred to as a “network slice”. Hereinafter, a network slice may be simply referred to as a “slice”.

Network slicing allows a telecommunications carrier to create slices according to service requirements of different service types, such as enhanced Mobile Broadband (eMBB), Ultra-Reliable and Low Latency Communications (URLLC), and massive Machine Type Communications (mMTC), for example, to optimize network resources.

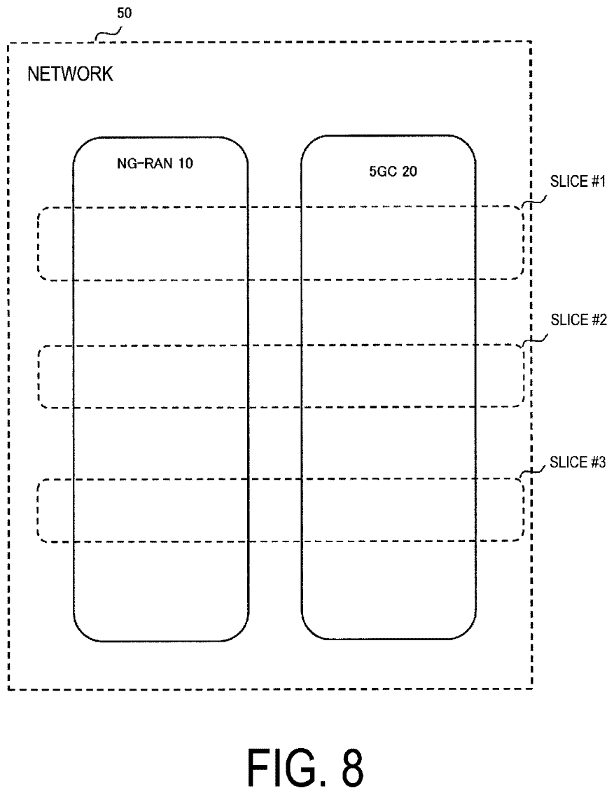

FIG. 8 is a diagram illustrating an example of network slicing.

Three slices (slices #1 to #3) are configured on a network 50 including the NG-RAN 10 and the 5GC 20. The slice #1 is associated with the service type called eMBB, the slice #2 is associated with the service type called URLLC, and the slice #3 is associated with the service type called mMTC. Further, three or more slices may be configured on the network 50. One service type may be associated with a plurality slices.

Each slice is provided with a slice identifier for identifying the slice. Examples of the slice identifier include Single Network Slicing Selection Assistance Information (S-NSSAI). The S-NSSAI includes an 8-bit slice/service type (SST). The S-NSSAI may further include a 24-bit slice differentiator (SD). The SST is information indicating a service type with which a slice is associated. The SD is information for differentiating a plurality of slices associated with the same service type. The information including a plurality of pieces of S-NSSAI is referred to as a Network Slice Selection Assistance Information (NSSAI).

One or more slices may be grouped to configure a slice group. A slice group is a group including one or more slices, and a slice group identifier is assigned to the slice group. The slice group may be configured by the core network (for example, the AMF 300), or may be configured by the radio access network (for example, a gNB 200). The UE 100 may be notified of the configured slice group.

Hereinafter, the term “network slice (slice)” may refer to S-NSSAI that is an identifier of a single slice or NSSAI that is a collection of pieces of S-NSSAI. The term “network slice (slice)” may refer to a slice group that is a group of one or more pieces of S-NSSAI or NSSAI.

The UE 100 determines a desired slice that the UE 100 desires to use. The desired slice may be referred to as an “intended slice”. In the first embodiment, the UE 100 determines a slice priority for each network slice (desired slice). For example, the NAS of the UE 100 determines the slice priority based on an operation status of an application in the UE 100 and/or a user operation/setting, and notifies the AS of slice priority information indicating the determined slice priority. Note that the NAS of the UE 100 may receive the slice priority information from the AMF 300. In this case, the NAS of the UE 100 may determine the slice priority based on the slice priority information received from the AMF 300.

### Overview of Slice-Specific Cell Reselection Procedure

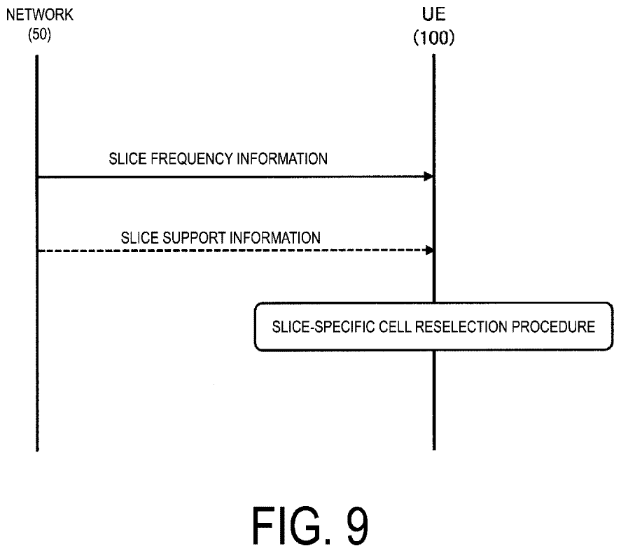

FIG. 9 is a diagram illustrating an overview of a slice-specific cell reselection (slice aware cell reselection or slice based cell reselection) procedure.

In the slice-specific cell reselection procedure, the UE 100 performs cell reselection processing based on slice frequency information provided from the network 50. The slice frequency information may be provided from the gNB 200 to the UE 100 through broadcast signaling (for example, a system information block) or dedicated signaling (for example, an RRC release message).

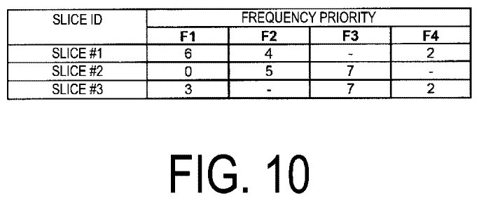

The slice frequency information is information indicating a correspondence relation between network slices, frequencies, and frequency priorities. For example, the slice frequency information indicates, for each slice (or slice group), a frequency (one or more frequencies) that supports the slice and a frequency priority assigned to each frequency. FIG. 10 illustrates an example of the slice frequency information.

In the example illustrated in FIG. 10, three frequencies F1, F2, and F4 are associated with the slice #1 as frequencies that support the slice #1. Among these three frequencies, the frequency priority of F1 is “6”, the frequency priority of F2 is “4”, and the frequency priority of F4 is “2”. In the example of FIG. 10, although the priority is set to be higher as the number of a frequency priority becomes greater, the priority may be higher as the number of a frequency priority becomes smaller.

Three frequencies F1, F2, and F3 are associated with the slice #2 as frequencies that support the slice #2. Among these three frequencies, the frequency priority of F1 is “0”, the frequency priority of F2 is “5”, and the frequency priority of F3 is “7”.

Three frequencies F1, F3, and F4 are associated with the slice #3 as frequencies that support the slice #3. Among these three frequencies, the frequency priority of F1 is “3”, the frequency priority of F3 is “7”, and the frequency priority of F4 is “2”.

Hereinafter, the frequency priority indicated in the slice frequency information may be referred to as a “slice-specific frequency priority” in order to be distinguished from the absolute priority in the cell reselection procedure of the related art.

As illustrated in FIG. 9, the UE 100 may perform the cell reselection processing, further based on slice support information provided from the network 50. The slice support information may be information indicating a correspondence relation between cells (for example, a serving cell and each neighboring cell) and network slices that are not provided or provided by the cell. For example, a cell may temporarily fail to provide some or all network slices due to congestion or the like. That is, even for a slice support frequency capable of providing a network slice, some cells in the frequency may not provide network slices. Based on the slice support information, the UE 100 may ascertain network slices not provided by each cell. Such slice support information may be provided from the gNB 200 to the UE 100 through broadcast signaling (for example, a system information block) or dedicated signaling (for example, an RRC release message).

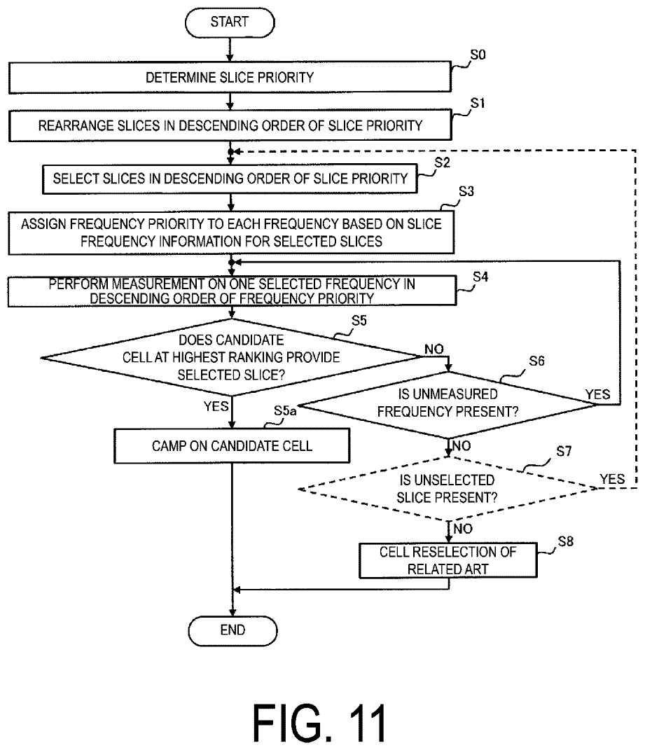

FIG. 11 is a flowchart illustrating a basic flow of the slice-specific cell reselection procedure. Before starting the slice-specific cell reselection procedure, the UE 100 is assumed to be in the RRC idle state or the RRC inactive state, and to receive and retain the above-mentioned slice frequency information. Further, the “slice-specific cell reselection” procedure indicates a “slice-specific cell reselection procedure”. Further, in the following, “slice-specific cell reselection” and “slice-specific cell reselection procedure” may be used in the same sense.

In step S0, the NAS of UE 100 determines the slice identifiers of the desired slices for the UE 100 and the slice priorities of the desired slices, and notifies the AS of the UE 100 of slice priority information including the determined slice priorities. The “desired slice” is an “Intended slice”, and includes a slice that is likely to be used, a candidate slice, a wanted slice, a slice with which communication is desired, a requested slice, an allowed slice, or an intended slice. For example, the slice priority of the slice #1 is determined to be “3”, the slice priority of the slice #2 is determined to be “2”, and the slice priority of the slice #3 is determined to be “1”. Although the priority is set to be higher as the number of a slice priority becomes greater, the priority may be higher as the number of a slice priority becomes smaller.

In step S1, the AS of the UE 100 rearranges the slices (slice identifiers), of which the NAS notifies the AS in step S0, in descending order of slice priority. A list of the slices arranged in this manner is referred to as a “slice list”.

In step S2, the AS of the UE 100 selects one network slice in descending order of slice priority. The network slice selected in this manner is referred to as a “selected network slice”.

In step S3, the AS of the UE 100 assigns a frequency priority to each frequency associated with the selected network slice. To be more specific, the AS of the UE 100 specifies the frequency associated with the slice based on the slice frequency information and assigns a frequency priority to the specified frequency. For example, when the selected network slice selected in step S2 is the slice #1, the AS of the UE 100 assigns the frequency priority “6” to the frequency F1, the frequency priority “4” to the frequency F2, and the frequency priority “2” to the frequency F4 based on the slice frequency information (for example, the information in FIG. 10). The AS of the UE 100 refers to a list of frequencies arranged in descending order of frequency priority as a “frequency list”.

In step S4, the AS of the UE 100 selects one of the frequencies in descending order of frequency priority for the selected network slice selected in step S2, and performs the measurement processing on the selected frequency. The frequency selected in this manner is referred to as a “selected frequency”. The AS of the UE 100 may rank the cells measured within the selected frequency in descending order of radio quality. Among the cells measured within the selected frequency, a cell satisfying a predetermined quality standard (i.e., a minimal required quality standard) is referred to as a “candidate cell”.

In step S5, the AS of the UE 100 specifies a cell at the highest rank based on results of the measurement processing in step S4, and determines whether the cell provides the selected network slice based on the slice support information. When determining that the cell at the highest rank provides the selected network slice (step S5: YES), the AS of the UE 100 reselects the cell at the highest rank and camps on that cell in step S5a.

On the other hand, when determining that the cell at the highest rank does not provide the selected network slice (step S5: NO), the AS of UE 100 determines in step S6 whether a frequency not measured is present on the frequency list created in step S3. In other words, the AS of the UE 100 determines whether a frequency to which the frequency priorities have been assigned in step S3 other than the selected frequency is present in the selected network slice. When determining that a frequency not measured is present (step S6: YES), the AS of the UE 100 resumes the processing for the frequency ranked at the next highest frequency priority, and performs the measurement processing using that frequency as a selected frequency (returns to the processing of step S4).

When determining that a frequency not measured is not present on the frequency list created in step S3 (step S6: NO), the AS of the UE 100 may determine in step S7 whether an unselected slice is present on the slice list created in step S1. In other words, the AS of the UE 100 may determine whether a network slice other than the selected network slice is present on the slice list. When it is determined that an unselected slice is present (step S7: YES), the AS of the UE 100 resumes the processing for the network slice ranked at the next highest slice priority, and selects that network slice as a selected network slice (returns to the processing of step S2). Further, in the basic flow indicated in FIG. 11, the processing of step S7 may be omitted.

When it is determined that an unselected slice is not present (step S7: NO), the AS of the UE 100 performs cell reselection processing of the related art in step S8. The cell reselection processing of the related art may mean an entirety of the typical (or legacy) cell reselection procedure illustrated in FIG. 7. The cell reselection processing of the related art may also mean only cell reselection processing (step S13) illustrated in FIG. 7. In the latter case, the UE 100 may use the measurement result of step S4 without measuring the radio qualities of the cells again.

### Paging

Now, paging according to the first embodiment will be described.

Paging is a technique for invoking the UE 100 in an RRC idle state or an RRC inactive state from the network. Paging is used for, for example, reception of data (voice or the like) or notification of emergency information.

With respect to paging, CN-initiated paging and RAN-initiated paging are present. CN-initiated paging may be referred to as “CN paging”. RAN-initiated paging may be referred to as “RAN paging”.

The CN paging is performed on the UE 100 in the RRC idle state. For example, upon receiving a notification of downlink data addressed to the CN 20, a core network apparatus in the UE 100 (for example, an AMF 300) generates a PAGING message including a Tracking Area Identity (TAI) list. The core network apparatus transmits the PAGING message to each gNB 200 included in the tracking area (TA). In response to reception of the PAGING message, each gNB 200 (or each cell) transmits the Paging message including an identifier of the UE 100. As a result, paging messages are simultaneously transmitted from the respective gNBs 200 (or respective cells) included in the TA.

On the other hand, the RAN paging is performed on the UE 100 in the RRC inactive state. For example, upon receiving downlink data addressed to the UE 100, or the like, the gNB 200 transmits a RAN paging message to another gNB (or another cell) in a RAN-based Notification Area (RNA). Each gNB 200 (or each cell) transmits the Paging message including the identifier of the UE 100. As a result, paging messages are simultaneously transmitted from the respective gNBs 200 (or respective cells) included in the RNA.

The UE 100 in the RRC idle state or the RRC inactive state can use Discontinuous Reception (DRX) to reduce power consumption. The UE 100 monitors a paging channel on one Paging Occasion (PO) per DRX cycle.

The UE 100 in the RRC idle state monitors a paging channel by CN paging. In the CN paging, the UE 100 monitors a paging channel by using a shorter cycle (DRX cycle) of a default cycle broadcasted by system information (System Information Block (SIB)) and a UE 100 specific cycle configured in a NAS message.

On the other hand, the UE 100 in the RRC inactive state monitors a paging channel by RAN paging. In the RAN paging, the UE 100 uses the shortest cycle (DRX cycle) among the default cycle transmitted in the SIB, the UE 100 specific cycle configured in the NAS message, and the UE 100 specific cycle configured in an RRC message.

However, the paging occasion (PO) in the CN paging and the paging occasion (PO) in the RAN paging are both based on the same UEID and thus overlap.

Upon receiving the paging message by using the paging channel, the UE 100 in the RRC idle state or the RRC inactive state recognizes that an incoming call or the like addressed to the UE 100 has been present. The UE 100 in the RRC idle state performs an RRC connection establishment procedure for the serving cell. The UE 100 in the RRC inactive state performs an RRC resume procedure for the serving cell (or a neighboring cell within the RNA). As a result, the UE 100 can be connected to the network, transition to the RRC connected state, and exchange messages (such as RRC messages) with the network.

### Communication Control Method According to First Embodiment

A slice is assumed to be associated with the paging message. The current 3GPP specifications do not allow the UE 100 to recognize the slice associated with the paging message. The UE 100 is assumed to be triggered by reception of the paging message to perform the RRC connection establishment procedure for the serving cell. In this case, the UE 100 can make RRC connection to the serving cell. However, the UE 100 fails to receive, from the serving cell, the provision of the service corresponding to the slice when the serving cell does not support the slice. In this case, the UE 100 is handed over to a neighboring cell to receive another service. In this manner, the serving cell may not necessarily be an appropriate cell for the UE 100.

An object of the first embodiment is to enable the UE 100 to connect to an appropriate cell.

Accordingly, in the first embodiment, the base station (for example, gNB 200) transmits, to a user equipment (for example, UE 100), a first paging message associated with a network slice.

As described above, since the slice is associated with the paging message, the UE 100 having received the paging message can recognize the slice for paging. For example, in a case of being capable of recognizing whether the serving cell supports the slice, the UE 100 can perform an RRC connection establishment procedure on the serving cell or perform a slice-specific cell reselection procedure for connection to a neighboring cell. Thus, the UE 100 can connect to an appropriate cell.

### Operation Example According to First Embodiment

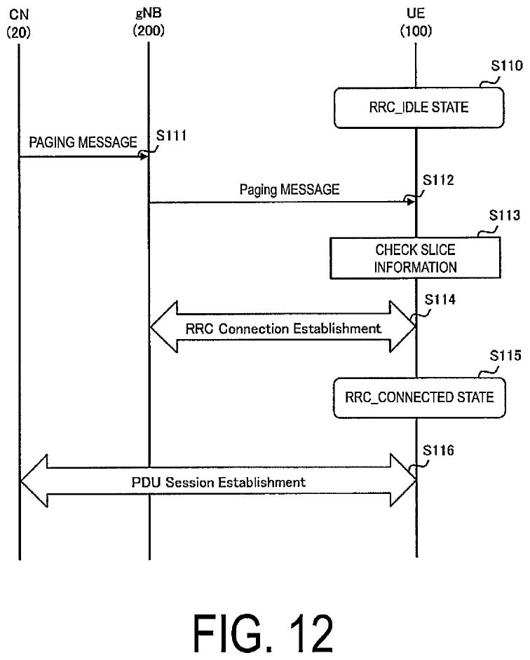

FIG. 12 is a flowchart illustrating an operation example according to the first embodiment. FIG. 12 illustrates an example of operation in the CN paging.

As illustrated in FIG. 12, in step S110, the UE 100 is in the RRC idle state.

In step S111, the CN 20 transmits, to the gNB 200, the PAGING message (e.g., a second paging message) with which a slice is associated. For example, a core network apparatus (e.g., the AMF 300, etc.) transmits, to the gNB 200, the PAGING message including slice information. The slice information represents a slice associated with the PAGING message. By transmitting the PAGING message including the slice information, the CN 20 transmits the PAGING message associated with the slice represented by the slice information. The PAGING message is an example of an NG message.

Here, the slice information may include information related to one slice. The slice information may include information related to a plurality of slices. When the slice information includes information related to a plurality of slices, the information related to the plurality of slices may be represented in a list format. Alternatively, the slice information itself may include information related to one slice, and the PAGING message may include a plurality of pieces of slice information.

The slice information may be represented by single slice assist information (S-NSSAI) (or slice number). Alternatively, the slice information may be represented by slice assist information (NSSAI). Alternatively, the slice information may be represented by a slice group number (Network Slice AS Group (NSAG)). An NSAG includes one or more pieces of S-NSSAI. The NSAG is configured by the RAN (i.e., gNB 200) and provided to the UE 100 via the AMF 300.

Alternatively, the slice information may be represented by Allowed NSSAI. The allowed NSSAI is assigned by the CN 20 and may include up to eight pieces of S-NSSAI. Alternatively, the slice information may be represented by Configured NSSAI. The configured NSSAI is NSSAI that is valid in one or more Public Land Mobile Networks (PLMNs) and may include up to 16 pieces of S-NSSAI. The NSAG may be configured out of the Configured NSSAI.

In step S112, in response to the reception of the PAGING message (step S111) from the CN 20, the gNB 200 transmits, to the UE 100, the Paging message (for example, the first paging message) associated with a slice. For example, the gNB 200 transmits the Paging message including the slice information. The slice information represents the slice associated with the Paging message. The slice information may be identical to the slice information received by the gNB 200 from the CN 20. By transmitting the Paging message including the slice information, the gNB 200 transmits the Paging message associated with the slice.

The Paging message includes a UE identifier (ue-Identity) of the UE 100. The gNB 200 may associate the slice information included in the Paging message with the ue-Identity included in the Paging message. When the Paging message includes a plurality of pieces of slice information, the plurality of pieces of slice information may be represented in a list format. The Paging message may also include a plurality of ue-Identities. When the Paging message includes a plurality of pieces of slice information and a plurality of ue-Identities, each entry of the plurality of pieces of slice information (that is, each piece of slice information) may be in a correspondence relationship with each entry of the plurality of ue-Identities (that is, each ue-Identity). Alternatively, for each piece of slice information, a corresponding ue-Identity may be listed.

In step S113, upon receiving the Paging message, the UE 100 checks whether the Paging message includes the slice information.

First, when the Paging message includes the slice information, the AS in UE 100 may notify the NAS in the UE 100 of the slice information. The NAS of the UE 100 manages slice priority. Accordingly, the AS of the UE 100 may notify the NAS of UE 100 of the slice information included in the Paging message, and in response to the reception of the Paging message, the NAS of UE 100 may update the slice priority of the slice represented by the slice information. The update of the slice priority is an example of predetermined processing. The NAS of the UE 100 may update the slice priority by increasing the slice priority of the slice by a value equal to or greater than a predetermined value. The NAS may update the slice priority of the slice to the highest priority (i.e., the intended slice). The NAS of the UE 100 may notify the AS of the UE 100 of the updated slice priority. For example, the NAS of the UE 100 may transmit, to the AMF 300, the NAS message including information indicating that the slice priority has been updated. Note that before paging is performed, the CN 20 may transmit, to the NAS of the UE 100, the NAS message including information indicating that the priority of the slice to be paged is to be changed (or that the prioritization of the slice to be paged is to be changed). The NAS of the UE 100 may update the slice priority (or change the prioritization of the slice) in accordance with the information.

Second, when the Paging message includes the slice information, the UE 100 may perform the slice-specific cell reselection procedure in response to receiving the Paging message. The UE 100 may perform the slice-specific cell reselection procedure in such a manner that the slice included in the slice information is configured with the highest slice priority (i.e., the intended slice). The slice-specific cell reselection procedure is an example of the predetermined processing.

Third, when the Paging message includes the slice information, the UE 100 may perform a slice-specific Random Access Channel (RACH) procedure in response to reception of the Paging message. The slice-specific random access procedure is a random access procedure performed using a different Physical Random Access Channel (PRACH) resource for each slice. The slice-specific random access procedure is an example of the predetermined processing. The UE 100 may select a PRACH resource associated with the slice information to perform a slice-specific random access procedure. Upon failing to select the PRACH resource associated with the slice information, the UE 100 may determine that the PRACH resource associated with the slice information has not been provided from the network, that is, the serving cell having transmitted the Paging message is a cell that does not support the slice included in the slice information. In this case, the UE 100 may perform the slice-specific cell reselection procedure.

In step S114, the UE 100 performs the RRC connection establishment procedure.

In step S115, the UE 100 connects to the gNB 200 and transitions to the RRC connected state. Note that, when the cell to which the UE 100 is connected does not correspond to the slice included in the slice information, the UE 100 may perform handover processing on the neighboring cell after the RRC connection.

In step S116, the UE 100 performs a PDU session establishment procedure on a cell included in the slice information included in the Paging message.

### Other Example According to First Embodiment

In the first embodiment, the example of the CN paging has been described. However, the present disclosure is not limited to the CN paging. For example, the first embodiment is also applicable to RAN paging. In this case, the UE 100 is in the RRC inactive state instead of being in the RRC idle state (step S110). In this case, the CN 20 transmits no PAGING message (step S111). In response to a transmission trigger for the Paging message (when the gNB 200 receives downlink data addressed to the UE 100, or when the gNB 200 receives control information addressed to the UE 100), the gNB 200 transmits the Paging message associated with the slice information (step S112). Then, the UE 100 checks the slice information (step S113), and executes RRC resume processing on the gNB 200.

Note that, during RAN paging, the UE 100 may perform an RRC resume procedure not on the serving cell (gNB 200) but on a cell (or neighboring cell) controlled by another gNB in the RNA. In this case, a RAN Paging message, which is an Xn message, is transmitted from the gNB 200 to which the UE 100 is connected last to the other gNB. In the gNB 200 to which the UE 100 is connected last, the slice information associated with (the bearer of) the DL data addressed to the UE 100 is included in the Xn message, which is then transmitted to the other gNB 200. Then, upon receiving the RAN paging message, the other gNB transmits, to the UE 100, the Paging message associated with the slice information (step S112).

Note that, for example, an Inactive-RNTI (I-RNTI) is used as a ue-Identity in the Paging message used in the RAN paging.

In the first embodiment, an example has been described in which the gNB 200 transmits the Paging message including the slice information. However, the present disclosure is not limited to this. For example, instead of transmitting the Paging message including the slice information, the gNB 200 may transmit, to the UE 100, the Paging message including frequencies supporting the slice represented by the slice information. By including the frequencies in the Paging message, the slice information may be associated with the Paging message. In this case, the UE 100 may perform the slice-specific cell reselection procedure with a frequency priority (for example, FIG. 10) for the frequencies included in the Paging message set equal to or larger than a threshold (or with the highest frequency priority set).

In the first embodiment, an example has been described in which the Paging message includes the slice information. However, the present disclosure is not limited to this. For example, the Paging message may not need to include the slice information. In this case, information representing association between a paging occasion (PO) and the slice may be transmitted by system information (SIB) or the like. In the UE 100, when the paging message is received on a certain paging occasion (PO), the slice associated with the paging occasion (PO) may be confirmed based on the information representing the association. The paging occasion (PO) of transmission of the Paging message (reception of the Paging message) confirms the slice associated with the paging occasion (PO). Accordingly, also in this case, the slice information can be considered to be associated with the Paging message.

### Second Embodiment

A second embodiment will be described. In the second embodiment, differences from the first embodiment will mainly be described.

The second embodiment is an example in which the UE 100 includes, in the Paging message, information designating processing to be performed after receiving the Paging message associated with the slice. To be more specific, after receiving the first paging message (for example, the Paging message associated with the slice information) at the user equipment (for example, the UE 100), the base station (for example, the gNB 200) transmits, to the user equipment, the first paging message including designated processing information designating the processing to be executed first.

As a result, upon receiving the Paging message, the UE 100 can execute processing in accordance with the information included in the designated processing information. Accordingly, the network side can configure, in advance, the UE 100 with processing to be executed after receiving the Paging message. The UE 100 can connect to an appropriate cell by executing processing in accordance with the designated processing information.

Note that, as described above, “designated processing information” may refer to information designating the processing to be performed first by the UE 100 after receiving the Paging message with which the slice is associated.

### Operation Example According to Second Embodiment

An operation example according to the second embodiment will be described.

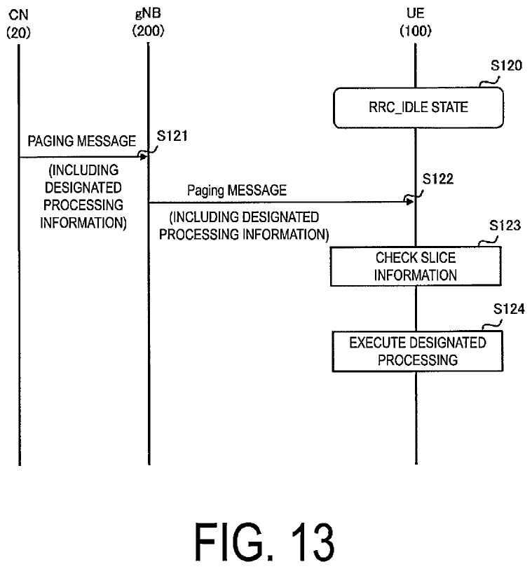

FIG. 13 is a diagram illustrating an operation example according to the second embodiment. FIG. 13 illustrates an example of the CN paging.

As illustrated in FIG. 13, in step S120, the UE 100 is in the RRC idle state.

As illustrated in FIG. 13, in step S121, the CN 20 transmits, to the gNB 200, a PAGING message including designated processing information. For example, a core network apparatus (e.g., AMF 300) included in the CN 20 transmits, to the gNB 200, the PAGING message including the designated processing information. As in the first embodiment, the PAGING message includes the slice information.

The processing designated by the designated processing information may be one of the slice-specific cell reselection procedure or the RRC connection establishment procedure. When the processing designated by the designated processing information is the slice-specific cell reselection procedure, the processing indicates that the UE 100 executes the slice-specific cell reselection procedure first after receiving the Paging message. When the processing designated by the designated processing information is the RRC connection establishment procedure, the processing indicates that the UE 100 executes the RRC connection establishment procedure first after receiving the Paging message.

In step S122, in response to receiving the PAGING message (step S121), the gNB 200 transmits, to the UE 100, the Paging message including the designated processing information. As in the first embodiment, the Paging message includes the slice information.

In step S123, the UE 100 checks the slice information and the designated processing information.

In step S124, the UE 100 executes the processing designated by the designated processing information.

First, when the process specified by the designated processing information is the slice-specific cell reselection procedure, the UE 100 may determine the slice included in the slice information to be the highest-priority cell (i.e., the intended slice) to perform the slice-specific cell reselection procedure. Subsequently, the UE 100 executes the RRC connection establishment procedure on the reselected cell.

Second, when the processing designated by the designated processing information is the RRC connection establishment procedure, the RRC connection establishment procedure is executed on the serving cell as in the first embodiment (step S114).

### Another Example of Second Embodiment

In the second embodiment, an example has been described in which the processing is designated by the designated processing information. For example, instead of the designated processing information, the processing executed after reception of the Paging message may be defined on the specifications of the UE 100 (or hard-coded in the UE 100). That is, the specifications may define whether the UE 100 executes the slice-specific cell reselection procedure or the RRC connection establishment procedure first as processing after reception of the Paging message.

In the second embodiment, an example has been described in which the gNB 200 designates the processing designated by the designated processing information, but the present disclosure is not limited to this. For example, the UE 100 may select one of designated processing operations. In this case, as the designated processing information, the CN 20 transmits, to the gNB 200, the PAGING message including both the slice-specific cell reselection procedure and the RRC connection establishment procedure (step S121). The gNB 200 also transmits the Paging message including both the slice-specific cell reselection procedure and the RRC connection establishment procedure, to the UE 100 as the designated processing information (step S122). The UE 100 selects and executes one of the slice-specific cell reselection procedure or the RRC connection establishment procedure as the first processing after receiving the Paging message (step S124).

As another example of the second embodiment, the UE 100 may be configured with the first processing after reception of the Paging message. For example, at the time of connection to the network before the UE 100 enters the RRC idle state, the processing may be designated by the NAS message from the AMF 300 to the UE 100. The NAS message includes the designated processing information. After receiving the Paging message including the slice information (step S122), the UE 100 executes the processing designated by the designated processing information included in the NAS message.

In the second embodiment, an example of the CN paging has been described. However, the implementation can also be employed for the RAN paging as in the first embodiment. In this case, the UE 100 is in the RRC inactive state instead of being in the RRC idle state (step S110). A transmission trigger for the Paging message causes the gNB 200 to transmit, to the UE 100, the Paging message including the designated processing information (step S122). In this case, the designated processing information may be one of the slice-specific cell reselection procedure or the RRC resume procedure. As described above, the other example described in the first embodiment can also be applied to the second embodiment.

### Third Embodiment

A third embodiment will be described. Also in the third embodiment, differences from the first embodiment will mainly be described.

In the third embodiment, an example will be described in which information is transmitted that indicates up to which cell the Paging message associated with a slice is supported or up to which region the Paging message associated with a slice is applied. To be more specific, the base station (for example, the gNB 200) transmits, to the user equipment (for example, the UE 100), the first paging message including slice support information (for example, the Paging message associated with a slice). Here, the slice support information includes information representing a region in which a slice is supported.

An SIB16 broadcast by the cell includes a list of slices supported by the neighboring cells (a list of allow-listed neighboring cells for slicing). Accordingly, the UE 100 can recognize what slices are supported in the neighboring cell only after receiving the SIB16.

However, the UE 100 cannot recognize what slices are supported in the neighboring cells until the SIB16 is received.

In the third embodiment, an example will be described in which the slice support information included in the Paging message is transmitted.

Thus, for example, upon receiving the Paging message without receiving the SIB16, the UE 100 can recognize up to which region (for example, the neighboring cell) in which the slice associated with the Paging message is supported. Depending on the result, the UE 100 can connect to an appropriate cell, such as performing the slice-specific cell reselection procedure or performing the RRC connection establishment procedure on the serving cell.

Here, the slice support information includes information representing a region in which a slice is supported. Specifically, the slice support information may include a cell ID (or PCI) of a cell supporting the slice. The cell ID may be in a list format. The list format is, for example, a PCI list. The slice support information may include identification information (Tracking Area Identity (TAI)) of a tracking area (TA) that uniformly supports the slice. The slice support information may include identification information (for example, a TAI list) of a registration area (RA) that uniformly supports the slice. The slice support information may include identification information (PLMN ID) of a PLMN that uniformly supports the slice.

### Operation Example According to Third Embodiment

An operation example according to the third embodiment will be described.

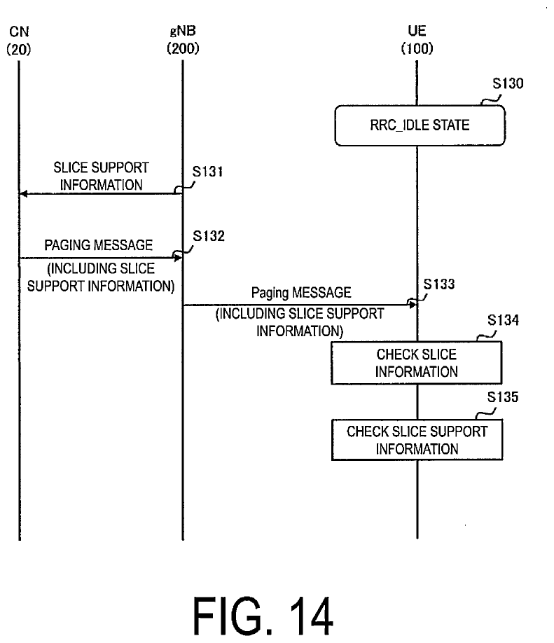

FIG. 14 is a diagram illustrating an operation example according to the third embodiment. FIG. 14 also illustrates an example of the CN paging.

As illustrated in FIG. 14, in step S130, the UE 100 is in the RRC idle state.

In step S131, the gNB 200 transmits the slice support information for the cell of the gNB 200 to the CN 20. For example, the gNB 200 includes, in the NG message, the slice support information including a slice #1 supported by a cell #1 and a slice #2 supported by a cell #2 and transmits the NG message to the core network apparatus (for example, the AMF 300).

The core network apparatus also receives, from other gNBs, the slice support information supported by cells in the other gNBs. Accordingly, the core network apparatus can recognize which cell (the cell #1 in the gNB 200, the cell #3 in another gNB, or the like) supports the slice #1, and which cell (the cell #2 in the gNB 200, the cell #4 in another gNB, or the like) supports the slice #2. The core network apparatus can also recognize that the slice #1 is uniformly supported in the TA, the slice #1 is uniformly supported in the RA, or the like. In this manner, the core network apparatus can recognize in which region each slice is uniformly supported.

In step S132, the CN 20 transmits, to the gNB 200, the PAGING message (e.g., the second paging message) including the slice information and the slice support information. For example, the core network apparatus transmits the slice associated with the PAGING message and the region in which the slice is supported, to the gNB 200 as the slice information and the slice support information, respectively.

In step S133, in response to the reception of the PAGING message (step S132), the gNB 200 transmits, to the UE 100, the Paging message (for example, the first paging message) including the slice information and the slice support information.

In step S134, the UE 100 checks the slice information included in the Paging message.

In step S135, the UE 100 checks the slice support information included in the Paging message.

The UE 100 may confirm, according to the slice support information, that the slice represented by the slice information is supported in the serving cell, and may perform the RRC connection establishment procedure (step S114) on the serving cell as in the first embodiment. Alternatively, the UE 100 may confirm, according to the slice support information, that the slice represented by the slice information is not supported in the serving cell, and perform the slice-specific cell reselection procedure.

### Another Example of Third Embodiment

In the third embodiment, an example of the CN paging has been described. However, the implementation can also be employed for the RAN paging as in the first embodiment. In this case, the UE 100 is in the RRC inactive state instead of being in the RRC idle state (step S130). In this case, the RRC resume procedure is executed instead of the RRC connection establishment procedure (step S114). When a transmission trigger for the Paging message occurs, the gNB 200 transmits, to the UE 100, the Paging message including the slice support information (step S133). As described above, the other example described in the first embodiment can also be applied to the third embodiment.

### Other Embodiments

A program causing a computer to execute each of the processing performed by the UE 100 or the gNB 200 may be provided. The program may be recorded on a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM. Circuits for executing processing performed by the UE 100 or the gNB 200 may be integrated, and at least a part of the UE 100 or the gNB 200 may be implemented as a semiconductor integrated circuit (chipset, System on a chip (SoC)).

The phrases “based on” and “depending on” used in the present disclosure do not mean “based only on” and “only depending on,” unless specifically stated otherwise. The phrase “based on” means both “based only on” and “based at least in part on”. The phrase “depending on” means both “only depending on” and “at least partially depending on”. The terms “include” and “comprise” do not mean “include only items stated” but instead mean “may include only items stated” or “may include not only the items stated but also other items”. The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a,” “an,” and “the” are added in the present disclosure through translation, these articles include the plural unless clearly indicated otherwise in context.

Embodiments have been described above in detail with reference to the drawings, but specific configurations are not limited to those described above, and various design variation can be made without departing from the gist of the present disclosure. All or some of the embodiments, operations, processes, and steps may be combined without being inconsistent.

### Supplementary Note

### Supplementary Note 1

A communication control method in a mobile communication system, the communication control method including:
transmitting, by a base station, a first paging message associated with a network slice to a user equipment.

### Supplementary Note 2

The communication control method according to Supplementary Note 1, further including: transmitting, by a core network apparatus to the base station, a second paging message associated with the network slice,
wherein the transmitting to the user equipment includes transmitting, by the base station to the user equipment, the first paging message in response to receiving the second paging message.

### Supplementary Note 3

The communication control method according to Supplementary Note 1 or Supplementary Note 2, further including:
performing, by the user equipment, predetermined processing in response to receiving the first paging message,
wherein the predetermined processing is any of update of a slice priority of the network slice, a slice-specific cell reselection procedure, or a slice-specific random access procedure.

### Supplementary Note 4

The communication control method according to any one of Supplementary Notes 1 to 3, wherein the transmitting to the user equipment includes transmitting, by the base station to the user equipment, the first paging message including slice information representing the network slice.

### Supplementary Note 5

The communication control method according to any one of Supplementary Notes 1 to 4, wherein the transmitting to the base station includes transmitting, by the core network apparatus to the base station, the second paging message including slice information representing the network slice, and
the transmitting to the user equipment includes transmitting, by the base station to the user equipment, the first paging message including the slice information in response to receiving the second paging message.

### Supplementary Note 6

The communication control method according to any one of Supplementary Notes 1 to 5, wherein the transmitting to the user equipment includes transmitting, by the base station to the user equipment, the first paging message including designated processing information designating processing to be executed first after the first paging message is received at the user equipment.

### Supplementary Note 7

The communication control method according to any one of Supplementary Notes 1 to 6, wherein the transmitting to the base station includes transmitting, by the core network apparatus to the base station, the second paging message including designated processing information designating processing to be executed in response to reception of the first paging message at the user equipment, and
the transmitting to the user equipment includes transmitting, by the base station to the user equipment, the first paging message including the designated processing information in response to receiving the second paging message.

### Supplementary Note 8

The communication control method according to any one of Supplementary Notes 1 to 7, wherein the processing included in the designated processing information includes one of the slice-specific cell reselection procedure and the RRC connection establishment procedure, or
one of the slice-specific cell reselection procedure and the RRC resume procedure.

### Supplementary Note 9

The communication control method according to any one of Supplementary Notes 1 to 8, wherein the transmitting to the user equipment includes transmitting, by the base station to the user equipment, the first paging message including slice support information, and the slice support information includes information representing a region in which the network slice is supported.

### Supplementary Note 10

The communication control method according to any one of Supplementary Notes 1 to 9, wherein the transmitting to the base station includes transmitting, by the core network apparatus to the base station, the second paging message including the slice support information, and
the transmitting to the user equipment includes transmitting, by the base station to the user equipment, the first paging message including the slice support information in response to receiving the second paging message.

### REFERENCE SIGNS

1: Mobile communication system
20: CN
100: UE
110: Receiver
120: Transmitter
130: Controller
200: gNB
210: Transmitter
220: Receiver
230: Controller
300: AMF

1. A communication control method in a mobile communication system, the communication control method comprising:
transmitting, by a radio access network node, a first paging message associated with a network slice to a user equipment.

2. The communication control method according to claim 1, further comprising:
transmitting, by a core network node to the radio access network node, a second paging message associated with the network slice,
wherein the transmitting to the user equipment comprises transmitting, by the radio access network node to the user equipment, the first paging message in response to receiving the second paging message.

3. The communication control method according to claim 1, further comprising:
performing, by the user equipment, predetermined processing in response to receiving the first paging message,
wherein the predetermined processing is any of update of a slice priority of the network slice, a slice-specific cell reselection procedure, or a slice-specific random access procedure.

4. The communication control method according to claim 1, wherein
the transmitting to the user equipment comprises transmitting, by the radio access network node to the user equipment, the first paging message comprising slice information representing the network slice.

5. The communication control method according to claim 2, wherein
the transmitting to the radio access network node comprises transmitting, by the core network node to the radio access network node, the second paging message comprising slice information representing the network slice, and
the transmitting to the user equipment comprises transmitting, by the radio access network node to the user equipment, the first paging message comprising the slice information in response to receiving the second paging message.

6. The communication control method according to claim 1, wherein
the transmitting to the user equipment comprises transmitting, by the radio access network node to the user equipment, the first paging message comprising designated processing information designating processing to be executed first after the first paging message is received at the user equipment.

7. The communication control method according to claim 2, wherein
the transmitting to the radio access network node comprises transmitting, by the core network node to the radio access network node, the second paging message comprising designated processing information designating processing to be executed in response to reception of the first paging message at the user equipment, and
the transmitting to the user equipment comprises transmitting, by the radio access network node to the user equipment, the first paging message comprising the designated processing information in response to receiving the second paging message.

8. The communication control method according to claim 6, wherein
the processing comprised in the designated processing information comprises
one of a slice-specific cell reselection procedure and an RRC connection establishment procedure, or
one of the slice-specific cell reselection procedure and an RRC resume procedure.

9. The communication control method according to claim 1, wherein
the transmitting to the user equipment comprises transmitting, by the radio access network node to the user equipment, the first paging message comprising slice support information, and
the slice support information comprises information representing a region in which the network slice is supported.

10. The communication control method according to claim 9, wherein
the transmitting to the radio access network node comprises transmitting, by the core network node to the radio access network node, a second paging message comprising the slice support information, and
the transmitting to the user equipment comprises transmitting, by the radio access network node to the user equipment, the first paging message comprising the slice support information in response to receiving the second paging message.

11. A user equipment comprising:
a receiver configured to receive a first paging message associated with a network slice from a radio access network node.

12. A radio access network node comprising:
a transmitter configured to transmit a first paging message associated with a network slice to a user equipment.
